(19) United States
(12) Patent Application Publication
(10) Pub. No.: US 2008/0019519 A1
(43) Pub. Date: Jan. 24, 2008

(54) System and method for secure facsimile transmission

(75) Inventors: William Su, Riverside, CA (US); Jianxin Wang, Anaheim, CA (US); Hongfeng Wei, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/453,654

(22) Filed: Jun. 15, 2006

(51) Int. Cl. H04N 1/44

(52) U.S. Cl. 380/243

(57) ABSTRACT

A system and method for the secure transmission of a facsimile, which verifies that a selected user transmitted the document and only allows for the designated recipient or recipients to receive the facsimile is provided. A sending user scans a document, which is then encrypted and digitally signed using the sender's private key, which is retrieved from a central authority or server. The digitally signed document is then encrypted using the recipient's public key. The encrypted digitally signed document is then faxed to the recipient. The device receiving the facsimile transmission then notifies the designated recipient of the receipt of the encrypted fax job. The recipient then logs onto the receiving device, which retrieves the sender's public key and the recipient's private key from the server. The retrieved keys are then used to decrypt the document and verify the identities of both the sender and the user.

### BACKGROUND OF THE INVENTION

This invention is directed to a system and method for the secure facsimile transmission. In particular, this invention is directed to a system and method for the secure transmission of a facsimile wherein the facsimile data is encrypted and only the intended recipient or recipients are able access the facsimile content.

Facsimile devices are typically not a secure mode of communication. A user of a facsimile device will generate a facsimile document, either a hard copy document or an electronic document, and then will transmit the document to a facsimile device associated with the designated recipient. In many situations, a facsimile receiving device is in a public location or one that is shared by many users. In addition, on occasion a facsimile can be mistakenly sent to an unintended facsimile device. In either instance, sensitive information is prone to be compromised. The receiving facsimile machine will generate the facsimile document and such document will be delivered to the recipient, either as a hard copy or as an electronic document. In certain situations, the facsimile document may contain confidential information or other information which either the sender or the recipient do not desire to be disseminated. In such a situation, the sender of such a facsimile will need ensure that the facsimile only reaches the recipient, which requires the sender to notify the recipient of the transmission of the facsimile. The recipient will then have to wait at the receiving facsimile device for the transmission to ensure that another user does not intercept the facsimile document. Some current facsimile devices allow for the encryption of digital data, but do not provide for the encryption of printed or hard copy facsimile documents.

Another problem is that current facsimile devices do not have the ability to verify that a specified user is the user that sent the facsimile to the recipient. As such, there is the possibility that the facsimile document was intercepted by another user and the information contained in the document disseminated. There is also the possibility that the facsimile document was intercepted by another user and altered, such that the recipient cannot rely on the data contained in the document. As such, there is a needed for a system and method for the secure facsimile transmission, which verifies that a selected user transmitted the document and only allows for the designated recipient to receive the facsimile.

The subject application overcomes the above mentioned problems and provides for secure facsimile transmission.

### SUMMARY OF THE INVENTION

In accordance the subject application, there is provided a system and method for secure facsimile transmission.

Further, in accordance with the subject application, there is provided a system and method for the secure transmission of a facsimile wherein the facsimile data is encrypted.

Still further, in accordance with the subject application, there is provided a system and method for the secure transmission of a facsimile, which verifies that a selected user transmitted the document and only allows for the designated recipient or recipients to receive the facsimile.

Still further, in accordance with the subject application, there is provided a system for secure facsimile transmission. The system includes a data storage associated with a key authority server adapted for storing profiles corresponding to each of a plurality of users, wherein the profiles include encryption key data associated with each profile. The system also includes receiving means adapted for receiving a facsimile request to complete a facsimile transmission from an associated user. The facsimile request includes address data corresponding to at least one designated recipient of the facsimile transmission. The system also comprises retrieving means adapted for retrieving, from the key authority server, profile data corresponding to the associated user after receipt of the facsimile request and encryption means adapted for generating an encrypted facsimile corresponding to a received request in accordance with key data associated with retrieved profile data corresponding to the associated user and the address data. The system further comprises output means adapted for commencing a transmission of the encrypted facsimile in accordance with the address data.

Still further, in accordance with the subject application, there is provided a method for secure facsimile transmission. Profiles corresponding to each of a plurality of users are first stored in a data storage means associated with a key authority server, wherein the profiles include encryption key data associated with each profile. The method includes receiving a facsimile request to complete a facsimile transmission from an associated user, wherein the facsimile request includes address data corresponding to at least one designated recipient of the facsimile transmission. Profile data corresponding to the associated user is retrieved from the key authority server after receipt of the facsimile request. An encrypted facsimile is generated corresponding to a received request in accordance with key data associated with retrieved profile data corresponding to the associated user and the address data. A transmission of the encrypted facsimile is then commenced in accordance with the address data.

Preferably, the encryption key data associated with each profile is comprised of a key pair inclusive of a public key and a private key and the generation of the encrypted facsimile is in accordance with a private key of the associated user and a public key for the at least one designated recipient.

In one embodiment, the transmission of the encrypted facsimile includes a digital signature representative of the private key. Preferably, the system and method include the ability to retrieve login data from the associated user, which login data is used for generation of the digital signature. More preferably, the login data is stored on an associated, portable memory device.

In another embodiment, the system and method have the ability to receive the encrypted facsimile and login data from the at least one designated recipient. The system and method also include the ability to access a profile of the at least one designated recipient from the key authority server in accordance with the login data and to decrypt a received encrypted facsimile in accordance with key data corresponding to the profile of the at least one designated recipient. Preferably, the system and method have the ability to prompt the at least one designated recipient for login data after receipt of the encrypted facsimile.

Still other advantages, aspects and features of the subject application will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject application is described with reference to certain figures, including:

FIG. 1 which is an overall system diagram for secure facsimile transmission system according to the subject application;

FIG. 2 is a flowchart illustrating the method for secure facsimile transmission from the sender facsimile device perspective according to the subject application; and

FIG. 3 is a flowchart illustrating the method for secure facsimile transmission from the recipient facsimile device perspective according to the subject application.

### DETAILED DESCRIPTION OF THE PREFERRED EMBODIMENT

The subject application is directed to a system and method for secure facsimile transmission. In particular, the subject application is directed to a system and method for the secure transmission of a facsimile wherein the facsimile data is encrypted. More particularly, the subject application is directed to a system and method for the secure transmission of a facsimile, which verifies that a selected user transmitted the document and only allows for the designated recipient or recipients to receive the facsimile.

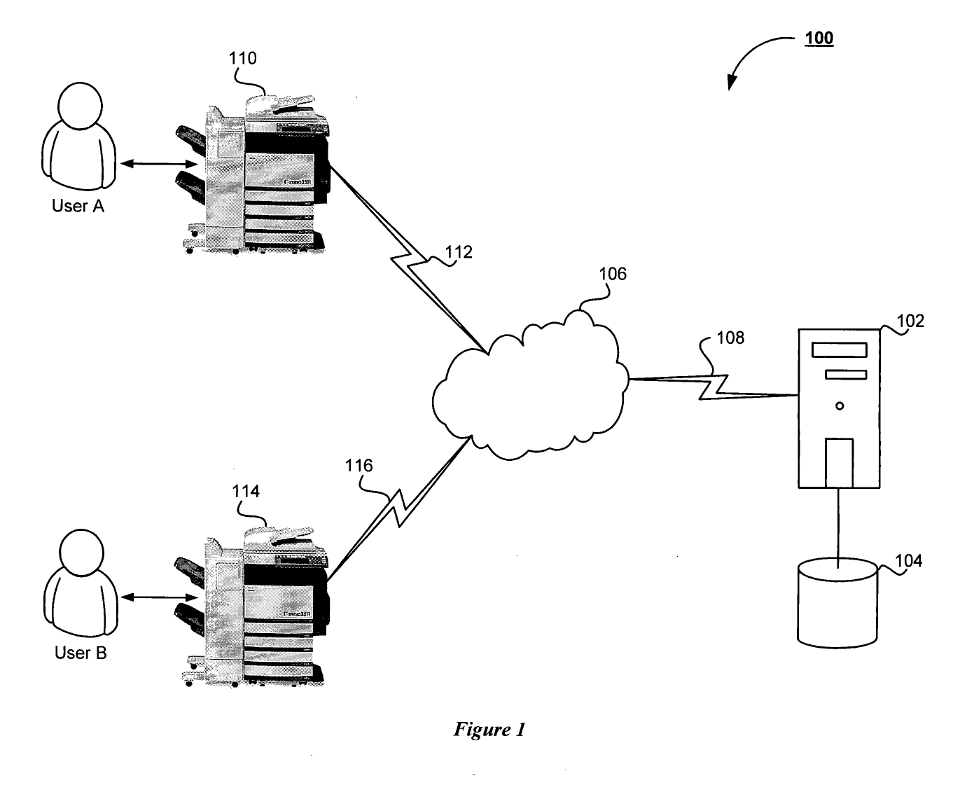

Turning now to FIG. 1, there is shown a diagram illustrating the system 100 in accordance with the subject application. As shown in FIG. 1, the system 100 includes a backend server 102, suitably adapted to provide a central public/private key authority. The skilled artisan will appreciate that the server 102 is suitably adapted to provide a controlling authority on user authentication, password verification, encryption key storage, and the like. Those skilled in the art will further appreciate that the server 102 is any hardware, software, or combination thereof, capable of providing authentication and verification services over a computer network. The server 102 is communicatively coupled to an encryption key database 104. As will be understood by those skilled in the art, the database 104 is any implemented on any mass storage device, known in the art, including, for example and without limitation, optical storage, magnetic storage, or the like. Preferably, the server 102 functions to manage the data stored in the database 104, wherein the data comprises public/private key pairs associated with a plurality of users.

The server 102 is communicatively coupled to a computer network 106 via a suitable communications link 108. As will be understood by those skilled in the art, the computer network 106 is any distributed computing environment known in the art enabling the exchange of data between two or more electronic devices. A suitable computer network includes, but is not limited to, the public switched telephone network, a local area network, a wide area network, the Internet, a personal area network, or the like. Communication between the computer network 106 and the server 102 is advantageously accomplished via a communications link 108. As will be understood by those skilled in the art, the communications link 108 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 of FIG. 1 further includes a sending document processing device 110 associated with sending user A. As illustrated in FIG. 1, the document processing device 110 is suitably represented as a multifunction peripheral device capable of providing a variety of document processing services to the user A, such as, for example and without limitation, electronic mail, scanning, copying, facsimile, document management, printing, and the like. Suitable commercially available document processing devices include, but are not limited to, the Toshiba e-Studio Series Controller. In one embodiment, the document processing device 110 is suitably equipped to receive a plurality of portable storage media, including without limitation, Firewire drive, USB drive, SD, MMC, XD, Compact Flash, Memory Stick, and the like. In the preferred embodiment of the subject application, a user-interface, associated with the document processing device 110, is suitably equipped to display a series of interactive graphical screens, whereupon an associated user inputs instructions, selects operations, and the like. It will be appreciated by those skilled in the art that a suitable user-interface includes, for example and without limitation, an alpha-numeric keypad, mouse, LCD screen, touch-screen interface, or any suitable combination thereof.

The system 100 also includes a recipient user B, associated with a receiving document processing device 114. Similar to the document processing device 110, the document processing device 114 is a multifunction peripheral device suitably adapted to provide a number of document processing services to the user B. As will be understood by those skilled in the art, the document processing services include, for example and without limitation, copying, scanning, facsimile, printing, electronic mail generation, document storage, document management, and the like. The receiving document processing device 114 is in data communication with the computer network 106 via a suitable communications link 116. As will be appreciated by those skilled in the art, the communications link 116 is any communications channel known in the art capable of establishing two-way communications between the computer network 106 and the document processing device 114. Examples of suitable communications links include, without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. In the preferred embodiment of the subject application, the document processing device 114 further includes an associated user-interface, such as a touch-screen interface, LCD display, or the like, via which the associated user B is able to log onto the server 102 over the computer network 106.

In operation, when the user A desires to securely transmit a facsimile to a designated recipient, e.g., user B, the user A inserts the document to be faxed into the sending document processing device 110. It will be appreciated by those skilled in the art that the document to be faxed to the recipient is capable of being in hardcopy form, such that it is scanned in accordance with standard scanning procedures, as known in the art, or alternatively present in electronic format as an attachment to an electronic message sent to the document processing device 110, or resident on a portable storage medium inserted into the sending document processing device 110. The user A then provides login information to the document processing device 110 in the form of a user identification and password combination. In one embodiment of the subject application, the user identification and password data is stored on a portable storage media, such as a smart card, or other portable memory device, capable of being read by the sending document processing device 110. It will be understood by those skilled in the art that prior to initiating any document processing operations, the users A and B have registered with the backend server 102, such that the backend server 102 contains, in the associated database 104, copies of the users' respective public and private encryption key pairs.

Once verified by the server 102, as established via the user identification information and password, user A designates a recipient for the facsimile transmission. The document processing device 110 then retrieves, from the server 102, user A's private encryption key and recipient user B's public encryption key. Preferably this retrieval is accomplished via a secure connection, as is known in the art, between the document processing device 110 and the server 102. The document to be faxed is then rendered, if necessary, into an electronic format. As will be understood by those skilled in the art, when in hardcopy format, the document is scanned by the document processing device so as to generate electronic image data representative of the document. The document is then encrypted by the document processing device 110 using user A's private key. The document processing device 110 then digitally signs the encrypted document via user A's private key and then encrypts the digitally signed encrypted document with the public key of user B. The encrypted digitally signed document is then transmitted, via facsimile, to user B at the receiving document processing device 114.

The receiving document processing device 114 receives the encrypted digitally signed document and places the document, i.e., the private fax job, into a queue of received fax jobs. When the private fax job reaches the head of the queue, the document processing device 114 transforms the job into a print-ready job via any means known in the art. The print-ready encrypted digitally signed document is then placed in a private job buffer associated with the receiving document processing device 114. A notification is then sent to user B informing the user that a private fax job has been received and is ready for output. As will be appreciated by those skilled in the art, suitable notification is capable of being accomplished via, for example and without limitation, pager, text message, electronic mail message, or the like.

User B, once physically present at the document processing device 114, logs onto the document processing device 114 in the same manner that user A logged onto the sending document processing device 110. Thus, user B provides, via the user-interface, user identification information and/or password, which is authenticated by the document processing device 114 via any suitable means, including, for example and without limitation, verification with the backend server 102. User B then releases the private fax job for output by the document processing device 114. The document processing device 114 then retrieves, from the server, user A's public encryption key and user B's private encryption key. Such retrieval, as will be understood by those skilled in the art, is accomplished via a secure communications connection established between the document processing device 114 and the backend server 102. The encrypted digitally signed document is then decrypted using the private key of user B to generate a digitally signed encrypted document. The digitally signed encrypted document is then decrypted using the public key of user A to generate a decrypted facsimile transmission, which is then output by the document processing device 114. It will be understood by those skilled in the art that the preceding system allows user B to verify that the sender of the document was in fact user A, as only user A would have access to user A's private key. User A is thereafter assured that only user B will receive a non-encrypted version of the document because only user B would have access to user B's private key.

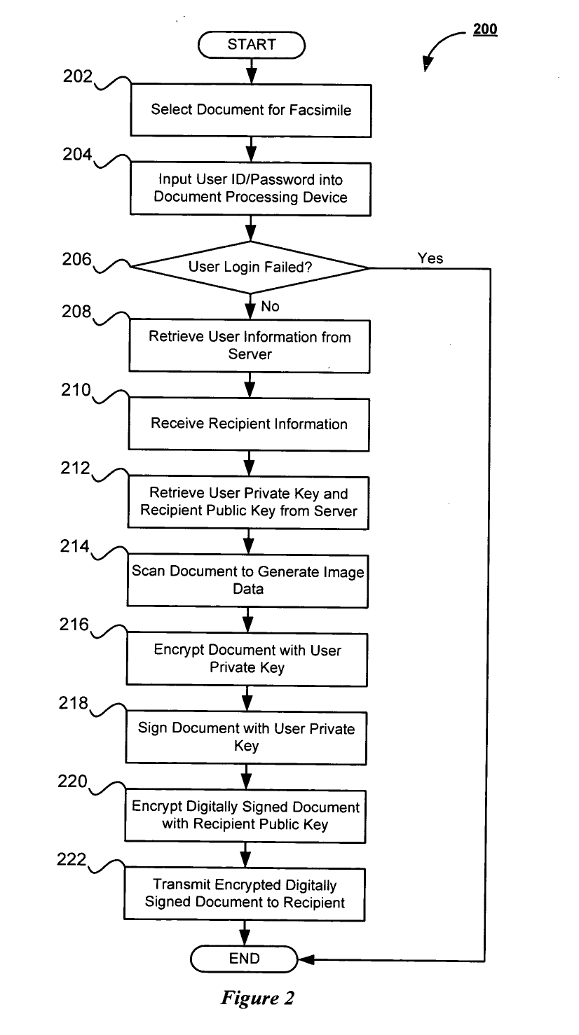

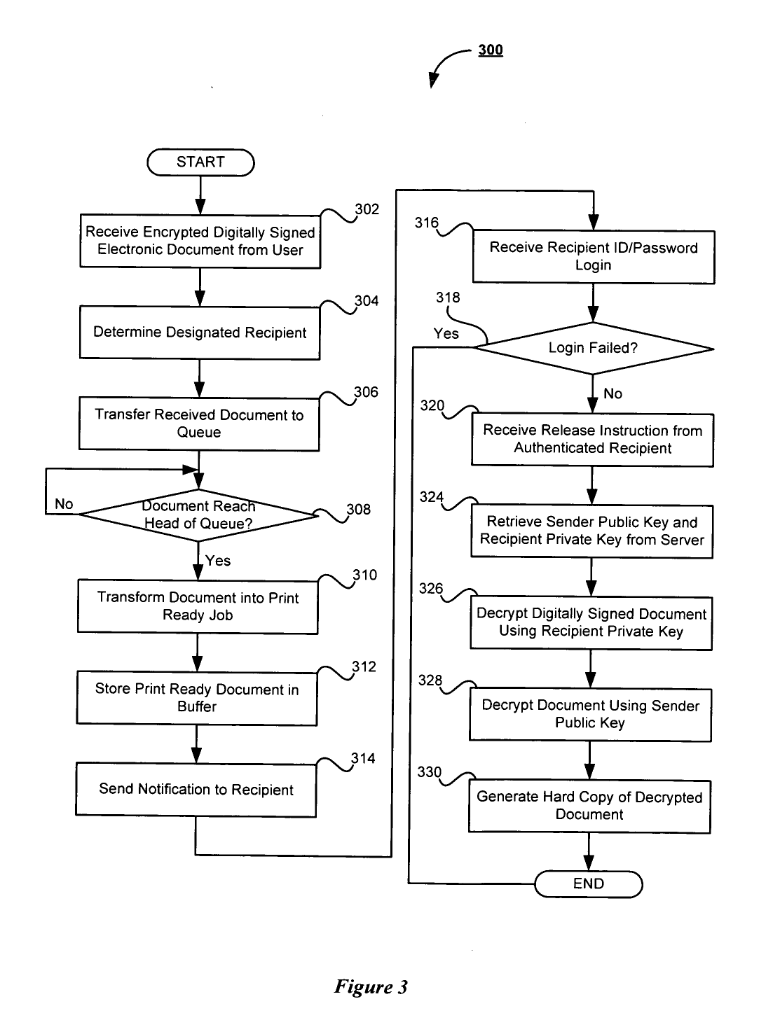

The foregoing system 100 will better be understood when interpreted in conjunction with the flowcharts illustrated in FIGS. 2 and 3. Referring now to FIG. 2, there is shown a flowchart 200 illustrating the method for secure facsimile transmission from the sender facsimile device perspective in accordance with the subject application. Beginning at step 202, user A selects a document for facsimile transmission. At step 204, user A inputs user identification and/or password into the sending document processing device 110 via the associated user-interface. The skilled artisan will appreciate that the user identification includes, for example and without limitation, a unique alpha-numeric designation associated with an individual user to which is associated a password, biometric data including fingerprints or retinal scans, and the like. In an alternate embodiment, the login data is advantageously stored on a portable storage medium, such as a smart card, or the like, which is capable of being detected and read by the document processing device 114. The document processing device 110 then determines, at step 206, whether the user login failed. It will be appreciated by those skilled in the art that the login determination is capable of being based upon verification and authentication procedures carried out by the document processing device 110, the server 102, or any combination thereof. When the login fails, the operation terminates and user A is prevented from submitting a private facsimile job.

When user A has been authenticated, flow proceeds to step 208, whereupon the document processing device 110 retrieves user information from the server 102. The skilled artisan will appreciate that the information retrieved at step 208 includes, for example and without limitation, an address book, a telephone book, electronic mail addressing, and the like. User A then selects the recipient, whereupon the recipient user information is retrieved from the server 102 at step 210. It will be understood by those skilled in the art that suitable recipient information includes, for example and without limitation, the facsimile number associated with the recipient, e.g., the facsimile number of the document processing device 114 associated with the recipient user B. The document processing device 110 then retrieves the sending user's private encryption key and the recipient user's public encryption key from the server 102 at step 212.

The sending document processing device 110 then scans the selected document at step 214 to generate electronic image data representative of the selected document. It will be appreciated that in the event the document to be transmitted to user B is already in electronic form, flow of the method described in FIG. 2 skips step 214 and proceeds directly to step 216. Once the electronic document data has been generated, it is encrypted at step 216 using the sending user's (user A's) private encryption key. The encrypted electronic document is then digitally signed to generate a digitally signed encrypted electronic document at step 218 using the private key of the sending user. The digitally signed electronic document is then encrypted at step 220 using the recipient's public key. The encrypted digitally signed electronic document, or image data, is then transmitted to the designated recipient at step 222, whereupon operations of the sending document processing device 110 terminates for the current facsimile transmission.

Attention now turns to FIG. 3, which illustrates a flowchart showing the method for secure facsimile transmission from the recipient facsimile device perspective in accordance with the subject application. The recipient document processing device 114 first receives a facsimile transmission containing image data representing an electronic document at step 302. The user designated as the recipient of the received transmission is then determined by the document processing device 114 from the data contained in the private facsimile transmission received from the sending document processing device 110 at step 304. The received facsimile transmission is then sent to a received fax queue at step 306, whereupon it resides until it has reached the head of the queue.

When it is determined at step 308 that the document has reached the head of the queue, flow proceeds to step 310, whereupon the image data is transformed into a print-ready job via any suitable means known in the art. The print ready document is then stored in a print-ready buffer at step 312, following which notification is sent to the designated recipient at step 314. It will be appreciated by those skilled in the art that suitable notification is advantageously transmitted to the recipient in the form of a text message, an electronic mail message, a page, or the like.

The document data remains in the print-ready queue until such time as the receiving user, user B, physically approaches the document processing device 114 and inputs his associated user identification and/or password at step 316. In the preferred embodiment, the login information is provided to the document processing device 114 by user B via the associated user-interface. The skilled artisan will appreciate that the user identification is a unique alpha-numeric designation associated with an individual user to which is associated a password. In an alternate embodiment, the login data is advantageously stored on a portable storage medium, such as a smart card, or the like, which is capable of being detected and read by the document processing device 114. In accordance with one aspect of the subject application, the user identification and password combination is suitably replaced with biometric data, such as retinal scan, fingerprint, or the like. In the event that the user identification and password supplied by user B are not authenticated by the document processing device 114, or the server 102, at step 318 the login is determined to have failed and the operation terminates.

When user B has been authenticated at step 318, flow proceeds to step 320, whereupon the user provides a facsimile release instruction to the document processing device 114, thereby indicating to the device 114 that a hardcopy output of the received private fax is desired. The document processing device 114 then retrieves the sending user's (user A's) public encryption key and the receiving user's (user B's) private encryption key from the server 102 at step 324. The encrypted digitally signed electronic data is then decrypted by the document processing device 114 at step 326 using the recipient's private key. This digitally signed encrypted document data is then decrypted by the document processing device 114 using the sending user's public encryption key at step 328. The document processing device 114 then generates a suitable hardcopy output of the faxed document at step 330.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A secure facsimile transmission system comprising:
a data storage associated with a key authority server adapted for storing profiles corresponding to each of a plurality of users, the profiles including encryption key data associated with each profile;
receiving means adapted for receiving a facsimile request to complete a facsimile transmission from an associated user, the facsimile request including address data corresponding to at least one designated recipient of the facsimile transmission;
retrieving means adapted for retrieving, from the key authority server, profile data corresponding to the associated user after receipt of the facsimile request;
encryption means adapted for generating an encrypted facsimile corresponding to a received request in accordance with key data associated with retrieved profile data corresponding to the associated user and the address data; and
output means adapted for commencing a transmission of the encrypted facsimile in accordance with the address data.

2. The secure facsimile transmission system of claim 1 wherein the encryption key data associated with each profile is comprised of a key pair inclusive of a public key and a private key, and wherein the encryption means includes means for generating the encrypted facsimile in accordance with a private key of the associated user and a public key for the at least one designated recipient.

3. The secure facsimile transmission system of claim 2 wherein the output means includes means adapted for transmitting the encrypted facsimile inclusive of a digital signature representative of the private key.

4. The secure facsimile transmission system of claim 3 further comprising:
means adapted for receiving the encrypted facsimile;
means adapted for receiving login data from the at least one designated recipient;
means adapted for accessing a profile of the at least one designated recipient from the key authority server in accordance with the login data; and
decryption means adapted for decrypting a received encrypted facsimile in accordance with key data corresponding to the profile of the at least one designated recipient.

5. The secure facsimile transmission system of claim 4 further comprising means adapted for prompting the at least one designated recipient for login data after receipt of the encrypted facsimile.

6. The secure facsimile transmission system of claim 3 further comprising means adapted for retrieving login data from the associated user, which login data is used for generation of the digital signature.

7. The secure facsimile transmission system of claim 6 wherein the login data is stored on an associated, portable memory device.

8. A secure facsimile transmission method comprising the steps of:
storing profiles corresponding to each of a plurality of users in a data storage means associated with a key authority server, the profiles including encryption key data associated with each profile;
receiving a facsimile request to complete a facsimile transmission from an associated user, the facsimile request including address data corresponding to at least one designated recipient of the facsimile transmission;
retrieving, from the key authority server, profile data corresponding to the associated user after receipt of the facsimile request;
generating an encrypted facsimile corresponding to a received request in accordance with key data associated with retrieved profile data corresponding to the associated user and the address data; and
commencing a transmission of the encrypted facsimile in accordance with the address data.

9. The secure facsimile transmission method of claim 8 wherein the encryption key data associated with each profile is comprised of a key pair inclusive of a public key and a private key, and wherein the step of generating an encrypted facsimile includes generating the encrypted facsimile in accordance with a private key of the associated user and a public key for the at least one designated recipient.

10. The secure facsimile transmission method of claim 8 wherein the step of commencing a transmission of the encrypted facsimile includes transmitting the encrypted facsimile inclusive of a digital signature representative of the private key.

11. The secure facsimile transmission method of claim 10 further comprising the steps of:
receiving the encrypted facsimile;
receiving login data from the at least one designated recipient;
accessing a profile of the at least one designated recipient from the key authority server in accordance with the login data; and
decrypting a received encrypted facsimile in accordance with key data corresponding to the profile of the at least one designated recipient.

12. The secure facsimile transmission method of claim 11 further comprising the step of prompting the at least one designated recipient for login data after receipt of the encrypted facsimile.

13. The secure facsimile transmission method of claim 10 further comprising the step of retrieving login data from the associated user, which login data is used for generation of the digital signature.

14. The secure facsimile transmission method of claim 13 wherein the login data is stored on an associated, portable memory device.

15. A computer-implemented method for secure facsimile transmission comprising the steps of:
storing profiles corresponding to each of a plurality of users in a data storage means associated with a key authority server, the profiles including encryption key data associated with each profile;
receiving a facsimile request to complete a facsimile transmission from an associated user, the facsimile request including address data corresponding to at least one designated recipient of the facsimile transmission;
retrieving, from the key authority server, profile data corresponding to the associated user after receipt of the facsimile request;
generating an encrypted facsimile corresponding to a received request in accordance with key data associated with retrieved profile data corresponding to the associated user and the address data; and
commencing a transmission of the encrypted facsimile in accordance with the address data.

16. The computer-implemented method for secure facsimile transmission of claim 15 wherein the encryption key data associated with each profile is comprised of a key pair inclusive of a public key and a private key, and wherein the step of generating an encrypted facsimile includes generating the encrypted facsimile in accordance with a private key of the associated user and a public key for the at least one designated recipient.

17. The computer-implemented method for secure facsimile transmission of claim 15 wherein the step of commencing a transmission of the encrypted facsimile includes transmitting the encrypted facsimile inclusive of a digital signature representative of the private key.

18. The computer-implemented method for secure facsimile transmission of claim 17 further comprising the steps of:
receiving the encrypted facsimile;
receiving login data from the at least one designated recipient;
accessing a profile of the at least one designated recipient from the key authority server in accordance with the login data; and
decrypting a received encrypted facsimile in accordance with key data corresponding to the profile of the at least one designated recipient.

19. The computer-implemented method for secure facsimile transmission of claim 18 further comprising the step of prompting the at least one designated recipient for login data after receipt of the encrypted facsimile.

20. The computer-implemented method for secure facsimile transmission of claim 17 further comprising the step of retrieving login data from the associated user, which login data is used for generation of the digital signature, wherein the login data is stored on an associated, portable memory device.
